(19) United States
(12) Patent Application Publication
(10) Pub. No.: US 2025/0099911 A1
(43) Pub. Date: Mar. 27, 2025

(54) GAS/LIQUID SEPARATOR AND METHOD OF USE

(71) Applicant: Oceaneering International, Inc., Houston, TX (US)

(72) Inventors: John FRICKER, Taylor Lake Village, TX (US); Tatsuya ARAI, League City, TX (US)

(73) Assignee: Oceaneering International, Inc., Houston, TX (US)

(21) Appl. No.: 18/899,237

(22) Filed: Sep. 27, 2024

Related U.S. Application Data
(60) Provisional application No. 63/585,867, filed on Sep. 27, 2023.

(51) Int. Cl. B01D 53/22; B01D 19/00; B01D 53/26; B64G 1/60

(52) U.S. Cl. CPC B01D 53/229; B01D 19/0031; B01D 53/265; B64G 1/60

(57) ABSTRACT

A gas/liquid separator comprises an enclosure, comprising a pressure fluid port, a liquid/gas separator bag comprising a non-porous bag a large-surface hydrophobic membrane disposed within the non-porous bag and configured to pass only gas and trap liquid behind; a sweep gas fluid inlet in fluid communication with an interior of the enclosure; a fluid outlet in fluid communication with the interior of the enclosure; and a mixed fluid inlet in fluid communication with the non-porous bag. A pressure management system is in fluid communication with the enclosure. A pre-separator comprises a membrane disposed at least partially within a housing and a condensing heat exchanger. Fluid is provided from a fluid source to the condensing heat exchanger and the condensing heat exchanger used to resolve a temperature of the fluid to a predetermined temperature range. Liquid present in the fluid is trapped within the housing the large-surface hydrophobic membrane used to pass only gas into an interior of the enclosure and trap liquid within the liquid/gas separator bag.

### CROSS-REFERENCE TO RELATED APPLICATIONS

This application claims priority through U.S. Provisional Application 63/585,867 filed on Sep. 27, 2023.

### BACKGROUND OF THE INVENTION

Separators may be required for use as part of a urinal to separate urine and air, especially as it applies to separating two-phase fluids in microgravity. Referring generally to FIG. 2, traditionally in zero-G, a urinal sucks both gas and liquid into the urinal using reduced pressure and separates liquid from gas with a spin separator in which liquid touches and adheres to a spinning drum wall which slings the liquid out to the sides. The spinning liquid rams into a pitot tube which pressurizes the liquid and pushes it out of the drum. These systems are large, have moving parts, and are susceptible to clogging.

Referring generally to FIG. 2, a wastewater management system in space applications produces concentrated wastewater or “brine” at the end of the process after water is removed from the wastewater. In order to recover even more water out of the brine, the brine is offloaded into a bag that selectively passes water vapor. Air (sweep gas) is blown over the bag to evaporate the water. The bag or sweep gas is typically heated to expedite water evaporation. The selectivity of the bag membrane also passes other gas species that vaporize so a gas scrubber is needed to remove offensive trace contaminants before returning the sweep gas to the cabin. One embodiment of this type of system is currently operating on the International Space Station (ISS) where the brine is offloaded from the urine processor into a brine bag, then the brine bag is placed in the brine processor.

In U.S. Pat. No. 11,365,137, referring to FIG. 1, wastewater (comprising urine, greywater, blackwater, or the like or a combination thereof) is stored in tank 38. As the process starts, pump 36 circulates wastewater in the loop. Redox cell 34 electrochemically processes wastewater to oxidize and reduce wastewater constituents. The gas bubbles and foams generated by the electrochemical process leave the wastewater loop from porous lumens in gas-liquid contactor (GLC) 32. The degassed wastewater returns to tank 38 and recirculates until the electrochemical process and evaporation are completed.

### BRIEF DESCRIPTION OF DRAWINGS

Various figures are included herein which illustrate aspects of embodiments of the disclosed inventions.

FIG. 1 is a flow diagram for an electro-oxidation membrane evaporator wastewater processor;

FIG. 2 is a flow diagram for a traditional gas-liquid separation system;

FIG. 3 is a block diagram for of a first embodiment of the disclosed invention;

FIG. 4 is a block diagram for of a second embodiment of the disclosed invention; and

FIG. 5 is a diagrammatic view of an exemplary brine bag.

### DETAILED DESCRIPTION OF EMBODIMENTS OF THE INVENTION

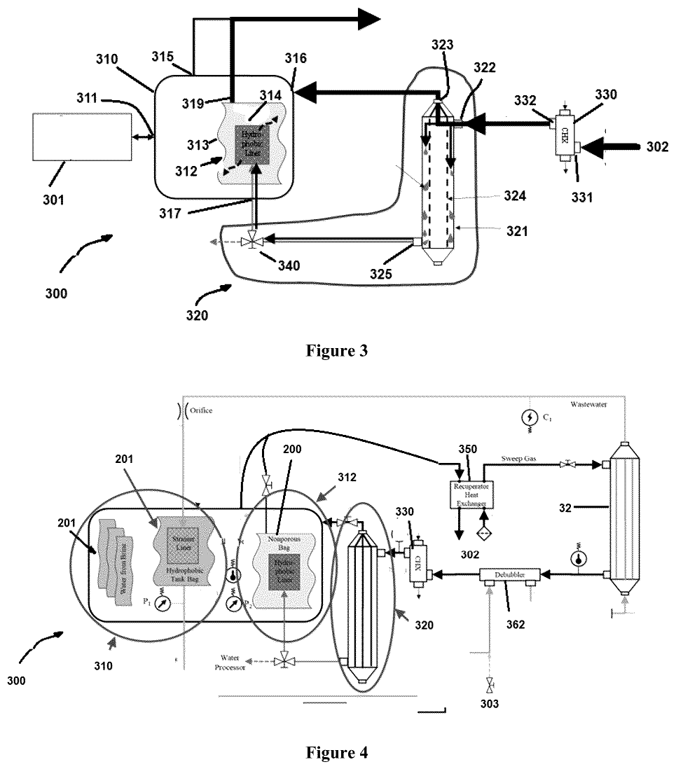

Referring to FIG. 3, gas/liquid separator 300 comprises enclosure 310; pressure management system 301 in fluid communication with enclosure 310; pre-separator 320; and condensing heat exchanger 330.

In embodiments, enclosure 310 comprises one or more pressure fluid ports 311; one or more liquid/gas separator bags 312 which typically comprises non-porous bag 313 and large-surface hydrophobic membrane 314 which is disposed within non-porous bag 313 and configured to pass only gas and traps liquid behind; one or more sweep gas fluid inlets 316 in fluid communication with an interior of enclosure 310; one or more fluid outlets 315 in fluid communication with the interior of enclosure 310; and one or more mixed fluid inlets 317 in fluid communication with non-porous bag 313.

Pre-separator 320 typically comprises housing 321; one or more mixed fluid inlet ports 322 in fluid communication with housing 322; one or more dry gas outlets 323 in fluid communication with housing 321 and with sweep gas fluid inlet 316; membrane 324 disposed at least partially within housing 321; and one or more mixed fluid outlets 325 in fluid communication with mixed fluid inlet 317.

Condensing heat exchanger 330 typically comprises one or more mixed fluid inlets 331 and one or more mixed fluid outlets 332 in fluid communication with at least one mixed fluid inlet port 322.

In embodiments, compressor 340 is also present and disposed intermediate, and in fluid communication with, mixed fluid outlet 325 and mixed fluid inlet 315. Compressor 340 typically comprises pressurizer 341; liquid separator 342; and liquid outlet 343 in fluid communication with liquid separator 342.

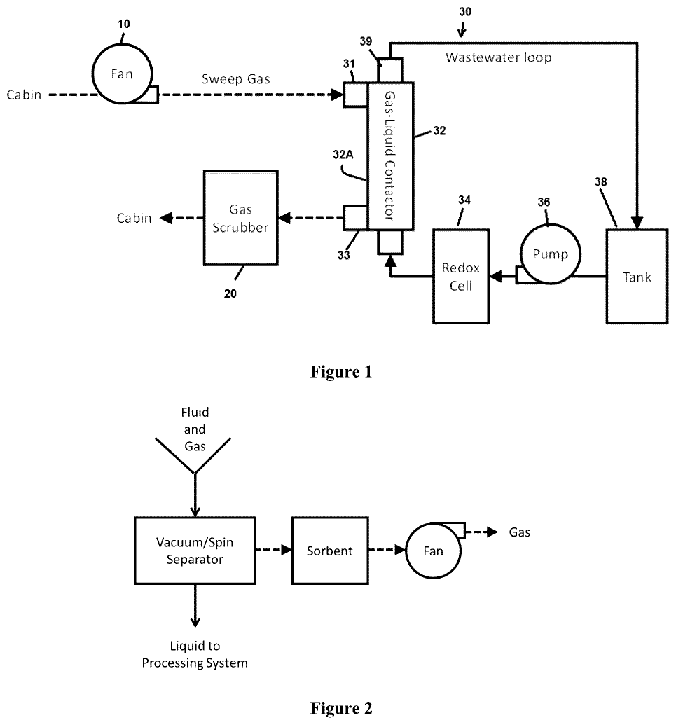

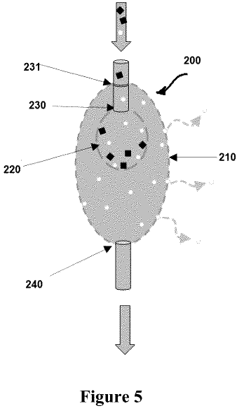

In embodiments, referring additionally to FIG. 5, one or more brine bags 200 are disposed at least partially within enclosure 310 and, optionally, within gas/liquid contactor 32 (FIG. 1). Each brine bag 200 comprises hydrophobic outer filter bag 210 comprising a fluid permeable membrane which is configured to allow a fluid to pass through hydrophobic outer filter bag 210 into enclosure 310; one or more hydrophilic inner bags 220 disposed at least partially within hydrophobic outer filter bag 210 where hydrophilic inner bags 220 comprise a liquid and fluid permeable membrane configured to retain a solid mass within hydrophilic inner bag 220; wastewater inlet pathway 230 sealed to and in fluid communication with hydrophilic inner bag 220 and configured to accept wastewater that comprises the fluid and the solid mass; and wastewater outlet pathway 240 in fluid communication with hydrophobic outer bag 210.

Typically, referring additionally to FIGS. 1 and 4, gas/liquid contactor 32 comprises housing 32A, comprising sweep gas inlet 31; wastewater outlet 39 in fluid communication with wastewater inlet pathway 30; and mixed fluid outlet 33 in fluid communication with condensing heat exchanger 330. Recuperator heat exchange 350 may also be present and in fluid communication with sweep gas inlet 31. Debubbler 362 may also be present and disposed intermediate, and in fluid communication with, mixed fluid outlet 33 and condensing heat exchanger 330.

In the operation of exemplary methods, referring back to FIGS. 3 and 4, the disclosed invention allows separation of small quantity liquid from large quantity gas flow. Although useful with EOME and wastewater processing, the disclosed invention is useful in other settings requiring gas/liquid separation in low or zero-G environments.

As described above, gas/liquid separator 300 includes condensing heat exchanger 330 which is configured to condense water from warm humid sweep gas from source 302, e.g., a cabin. The resulting 2-phase fluid contains small amount of liquid water that has to be separated for water recovery. In embodiments, in order to separate a large volumetric flow of gas and small volumetric flow of liquid, pre-separator 320 can be useful. A large-surface hydrophobic membrane such as membrane 324 in brine bag 200 only passes gas and traps liquid behind. Liquid and small amount of gas will be transferred to liquid/gas separator bag 312 for further degassing. A pressure management system, e.g., pressure management system 301 and/or fans which are part of compressor 340, may be used for enclosure 310 that holds liquid/gas separator bag 312 to squeeze collected water out.

The disclosed invention may be incorporated into a Microgravity Electro-Oxidation Membrane Evaporator (FIG. 1) but, as illustrated in FIGS. 3-4, adds enclosure 310, brine bags 200, liquid/gas separator bag 312, and pre-separator 320 to make an electro oxidation and membrane evaporator (“EOME”) function in microgravity where there is no gravity force to separate liquid and gas phases, and to incorporate additional functions into the EOME process, such as capturing condensate, brine processing, separating two phase fluid flows, improving ease of operation by incorporating filtering into consumable tank bags, and the like, or a combination thereof.

In an embodiment, a large volumetric flow of gas and small volumetric flow of liquid may be separated using gas/liquid separator 300 by providing fluid, e.g., urine, from fluid source 302 to condensing heat exchanger 330; using condensing heat exchanger 330 to resolve a temperature of the fluid to a predetermined temperature range; providing the fluid at the resolved predetermined temperature range to mixed fluid inlet port 322; trapping liquid present in the fluid within housing 321; providing a gas component of the fluid to sweep gas fluid inlet 316 through dry gas outlet 323; providing the gas component and the trapped liquid to mixed fluid inlet 317 via mixed fluid outlet 325; and using large-surface hydrophobic membrane 314 to pass only gas present in the fluid into gas passage 319, which is in fluid communication with an interior of enclosure 310 or with non-porous bag 313, and trap liquid present in the fluid within hydrophobic membrane 314.

Liquid and small amounts of gas may be provided to liquid/gas separator bag 312 for further degassing. In addition, pressure management system 301 may be used to squeeze collected water out.

In embodiments, brine bag 200 comprises a predetermined number of selectively replaceable brine bags (201) which may be stored in enclosure 310 and the method may further comprise replacing a selectively replaceable brine bag 201 with a new selectively replaceable brine bag 201 of the selectively replaceable brine bags 201 inside 310 enclosure when selectively replaceable brine bag 201 contains a predetermined amount of liquid. Replacing selectively replaceable brine bag 201 may comprise using one or more quick disconnects. In embodiments using a plurality of selectively replaceable brine bags 201, a replaced selectively replaceable brine bag 201 may be left in enclosure 201 and water allowed to continue to evaporate out of brine present in replaced selectively replaceable brine bag 201 and/or enclosure 310 into the sweep gas while it is stored in enclosure 310 to further allow water recovery from brine in the replaced selectively replaceable brine bag 201 to occur in parallel with normal urine processing.

The foregoing disclosure and description of the inventions are illustrative and explanatory. Various changes in the size, shape, and materials, as well as in the details of the illustrative construction and/or an illustrative method may be made without departing from the spirit of the invention.

1. A gas/liquid separator, comprising:
a) an enclosure, comprising:
i) a pressure fluid port;
ii) a liquid/gas separator bag, comprising:
(1) a non-porous bag; and
(2) a large-surface hydrophobic membrane disposed within the non-porous bag and configured to pass only gas and trap liquid behind;
iii) a sweep gas fluid inlet in fluid communication with an interior of the enclosure;
iv) a fluid outlet in fluid communication with the interior of the enclosure; and
v) a mixed fluid inlet in fluid communication with the non-porous bag;
b) a pressure management system in fluid communication with the enclosure;
c) a pre-separator, comprising:
i) a housing;
ii) a mixed fluid inlet port in fluid communication with the housing;
iii) a dry gas outlet in fluid communication with the housing and with the sweep gas fluid inlet;
iv) a membrane disposed at least partially within the housing; and
v) a mixed fluid outlet in fluid communication with the mixed fluid inlet; and
d) a condensing heat exchanger, comprising:
i) a mixed fluid inlet; and
ii) a mixed fluid outlet in fluid communication with the mixed fluid inlet port.

2. The gas/liquid separator of claim 1, further comprising a compressor disposed intermediate, and in fluid communication with, the mixed fluid outlet and the mixed fluid inlet.

3. The gas/liquid separator of claim 2, wherein the compressor comprises:
a) a pressurizer;
b) a liquid separator; and
c) a liquid outlet in fluid communication with the liquid separator.

4. The gas/liquid separator of claim 1, further comprising:
a) a brine bag disposed at least partially within the enclosure, comprising:
i) a hydrophobic outer filter bag, comprising a fluid permeable membrane, the fluid permeable membrane configured to allow a fluid to pass through the hydrophobic outer filter bag into the enclosure;
ii) a hydrophilic inner bag disposed at least partially within the hydrophobic outer filter bag, comprising a liquid and fluid permeable membrane configured to retain a solid mass within the hydrophilic inner bag;
iii) a wastewater inlet pathway sealed to and in fluid communication with the hydrophilic inner bag, the wastewater inlet pathway configured to accept wastewater that comprises the fluid and the solid mass; and
iv) a wastewater outlet pathway in fluid communication with the hydrophobic outer filter bag; and
b) a gas/liquid contactor, comprising:
i) a housing, comprising:
ii) a sweep gas inlet;
iii) a wastewater outlet in fluid communication with the wastewater inlet pathway; and
iv) a mixed fluid outlet in fluid communication with the condensing heat exchanger.

5. The gas/liquid separator of claim 4, further comprising a recuperator heat exchange in fluid communication with the sweep gas inlet.

6. The gas/liquid separator of claim 4, further comprising a debubbler disposed intermediate, and in fluid communication with, the mixed fluid outlet and the condensing heat exchanger.

7. A method to separate a large volumetric flow of gas and small volumetric flow of liquid using a gas/liquid separator comprising an enclosure, comprising a pressure fluid port, a liquid/gas separator bag comprising a non-porous bag and a large-surface hydrophobic membrane disposed within the non-porous bag and configured to pass only gas and trap liquid behind, a sweep gas fluid inlet in fluid communication with an interior of the enclosure, a fluid outlet in fluid communication with the interior of the enclosure, and a mixed fluid inlet in fluid communication with the non-porous bag, a pressure management system in fluid communication with the enclosure, a pre-separator comprising a housing, a mixed fluid inlet port in fluid communication with the housing, a dry gas outlet in fluid communication with the housing and with the sweep gas fluid inlet, a membrane disposed at least partially within the housing, and a mixed fluid outlet in fluid communication with the mixed fluid inlet, and a condensing heat exchanger comprising a mixed fluid inlet and a mixed fluid outlet in fluid communication with the mixed fluid inlet port, the method comprising:
a) providing fluid from a fluid source (302) to the condensing heat exchanger;
b) using the condensing heat exchanger to resolve a temperature of the fluid to a predetermined temperature range;
c) providing the fluid at the resolved temperature predetermined temperature range to the mixed fluid inlet port;
d) trapping liquid present in the fluid within the housing;
e) providing a gas component of the fluid to the sweep gas fluid inlet through the dry gas outlet;
f) providing the gas component and the trapped liquid to the mixed fluid inlet via the mixed fluid outlet; and
g) using the large-surface hydrophobic membrane to pass only gas into an interior of the enclosure or into the non-porous bag and trap liquid within the liquid/gas separator bag.

8. The method to separate a large volumetric flow of gas and small volumetric flow of liquid of claim 7, further comprising providing liquid and small amounts of gas to the gas/liquid separator for further degassing.

9. The method to separate a large volumetric flow of gas and small volumetric flow of liquid of claim 7, further comprising using the pressure management system to squeeze collected water out.

10. The method to separate a large volumetric flow of gas and small volumetric flow of liquid of claim 7, wherein:
a) the gas/liquid separator further comprises:
i) a predetermined number of selectively replaceable brine bags, each brine bag disposed at least partially within the enclosure and comprising a hydrophobic outer filter bag, comprising a fluid permeable membrane that is configured to allow a fluid to pass through the hydrophobic outer filter bag into the enclosure, a hydrophilic inner bag that is disposed at least partially within the hydrophobic outer filter bag and comprises a liquid and fluid permeable membrane configured to retain a solid mass within the hydrophilic inner bag, a wastewater inlet pathway sealed to and in fluid communication with the hydrophilic inner bag where the wastewater inlet pathway is configured to accept wastewater that comprises the fluid and the solid mass, and a wastewater outlet pathway in fluid communication with the hydrophobic outer filter bag; and
ii) a gas/liquid contactor, comprising a housing that comprises a sweep gas inlet, a wastewater outlet in fluid communication with the wastewater inlet pathway, and a mixed fluid outlet in fluid communication with the condensing heat exchanger; and
b) the method further comprises replacing a selectively replaceable brine bag with a new selectively replaceable brine bag of the selectively replaceable brine bags inside the enclosure when it contains a predetermined amount of liquid.

11. The method to separate a large volumetric flow of gas and small volumetric flow of liquid of claim 10, wherein replacing the selectively replaceable brine bag comprises using a quick disconnect.

12. The method to separate a large volumetric flow of gas and small volumetric flow of liquid of claim 10, wherein the selectively replaceable brine bag comprises a plurality of selectively replaceable brine bags stored in the enclosure.

13. The method to separate a large volumetric flow of gas and small volumetric flow of liquid of claim 12, further comprising:
a) leaving a replaced brine bag in the enclosure; and
b) allowing water to continue to evaporate out of the brine into the sweep gas while it is stored in the enclosure to further allow water recovery from brine in the replaced selectively replaceable brine bag to occur in parallel with normal urine processing.
